(19) United States
(12) Patent Application Publication
(10) Pub. No.: US 2014/0287312 A1
(43) Pub. Date: Sep. 25, 2014

(54) POSITIVE ACTIVE MATERIAL FOR A RECHARGEABLE LITHIUM BATTERY AND RECHARGEABLE LITHIUM BATTERY INCLUDING THE SAME

(71) Applicant: SAMSUNG SDI CO., LTD., YONGIN-SI (KR)

(72) Inventors: Young-Jin CHOI, Yongin-si (KR); Sung-Hoon KIM, Yongin-si (KR); Dong-Hwan YU, Yongin-si (KR); Young-Soo JUNG, Yongin-si (KR); Ji-Yong LEE, Yongin-si (KR)

(73) Assignee: SAMSUNG SDI CO., LTD., YONGIN-SI (KR)

(21) Appl. No.: 14/070,669

(22) Filed: Nov. 4, 2013

(30) Foreign Application Priority Data
Mar. 20, 2013 (KR) 10-2013-0029989

(51) Int. Cl. H01M 4/485; H01M 4/525; H01M 4/505

(52) U.S. Cl. CPC H01M 4/485; H01M 4/505; H01M 4/525
USPC 429/223; 252/182.1

(57) ABSTRACT

A positive active material for a rechargeable lithium battery and a rechargeable lithium battery including the same, the positive active material comprising a compound represented by the following Chemical Formula 1:

LiₐNiₓCo_{y}Mn_{z}M_{w}O₂. [Chemical Formula 1]

### CROSS-REFERENCE TO RELATED APPLICATION

Korean Patent Application No. 10-2013-0029989 filed on Mar. 20, 2013, in the Korean Intellectual Property Office, and entitled: “POSITIVE ACTIVE MATERIAL FOR RECHARGEABLE LITHIUM BATTERY, AND RECHARGEABLE LITHIUM BATTERY INCLUDING SAME,” is incorporated by reference herein in its entirety.

### BACKGROUND

1. Field

Embodiments relate to a positive active material for a rechargeable lithium battery and a rechargeable lithium battery including the same.

2. Description of the Related Art

Lithium rechargeable batteries may be used as a power source for small portable electronic devices. The lithium rechargeable batteries may use an organic electrolyte solution and thus may have a discharge voltage that is at least twice as high as that of a battery using an alkali aqueous solution. Accordingly, lithium rechargeable batteries have high energy density.

### SUMMARY

Embodiments are directed to a positive active material for a rechargeable lithium battery and a rechargeable lithium battery including the same.

The embodiments may be realized by providing a positive active material for a rechargeable lithium battery, the positive active material including a compound represented by the following Chemical Formula 1:

LiₐNiₓCo_{y}Mn_{z}M_{w}O₂ [Chemical Formula 1]

wherein, in Chemical Formula 1, M is Ti, or Zr, and a, x, y, z, and w satisfy the following relations: 0.90≦a≦1.11, 0.33≦x≦0.80, 0.10≦y≦0.33, 0.09≦z≦0.33, 0<w≦0.03, and x+y+z+w=1.

In Chemical Formula 1, M may be Ti, and 0.005≦w≦0.030.

In Chemical Formula 1, M may be Ti, and 0.005≦w≦0.020.

In Chemical Formula 1, M may be Zr, and 0.001≦w≦0.030.

In Chemical Formula 1, M may be Zr, and 0.001≦w≦0.020.

The positive active material may have a structure of a secondary particle including aggregated primary particles, and an average particle diameter of the primary particle may be about 0.1 μm to about 1 μm.

An average particle diameter of the secondary particle may be about 3 μm to about 8 μm.

In Chemical Formula 1, 0.001≦w≦0.006.

The embodiments may also be realized by providing a rechargeable lithium battery including a positive electrode, the positive electrode including the positive active material according to an embodiment, a negative electrode, and an electrolyte.

### BRIEF DESCRIPTION OF THE DRAWINGS

Features will become apparent to those of ordinary skill in the art by describing in detail exemplary embodiments with reference to the attached drawings in which:

FIG. 1 illustrates a perspective view showing a rechargeable lithium battery according to one embodiment.

FIG. 2 illustrates a scanning electron microscope (SEM) image of a positive active material according to Example 1.

FIG. 3 illustrates an element analysis image of the positive active material according to Example 1.

FIG. 4 illustrates a scanning electron microscope (SEM) image of a positive active material according to Example 2.

FIG. 5 illustrates a graph showing discharge retention of rechargeable lithium battery cells according to Examples 1 and 2 and Comparative Examples 1 to 3 according to C-rate.

FIG. 6 illustrates a graph showing power characteristics of the rechargeable lithium battery cells according to Examples 1 and 2 and Comparative Examples 1 to 3.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there may be no intervening elements present.

In one embodiment, a positive active material for a rechargeable lithium battery including a compound represented by the following Chemical Formula 1 is provided.

LiₐNiₓCo_{y}Mn_{z}M_{w}O₂ [Chemical Formula 1]

In Chemical Formula 1, M may be Ti, or Zr, 0.90≦a≦1.11, 0.33≦x≦0.80, 0.10≦y≦0.33, 0.09≦z≦0.33, 0<w≦0.03, and x+y+z+w=1.

In Chemical Formula 1, a is a mole ratio of Li, x is a mole ratio of Ni, y is a mole ratio of Co, z is a mole ratio of Mn, and w is a mole ratio of M.

The positive active material may be prepared by doping titanium (Ti) or zirconium (Zr) in a predetermined amount on a three-component-based composite oxide of nickel-cobalt-manganese.

The nickel-cobalt-manganese composite oxide may realize high-rate charge and discharge characteristics and high-rate power characteristics of a battery. For example, as the nickel is included in greater amounts in the composite, the composite may have a higher energy density and may be more advantageous in terms of a cost.

However, as the nickel is included in greater amounts, the composite may exhibit deteriorated thermal stability and cycle-life characteristic of a battery may likewise be deteriorated. For example, divalent nickel ions (having a similar ion radius to lithium ions) may move to an empty space produced when the lithium ions are deintercalated from a crystal lattice. Thus, the nickel-cobalt-manganese-based positive active material may have a defect on a metal-oxygen layer, and capacity may be deteriorated as cycles repeated. In addition, the defect may facilitated undesirable intercalation of oxygen from the active material and may deteriorate thermal stability of a battery.

The positive active material according to an embodiment may have a strong bond of titanium and oxygen or a strong bond of zirconium and oxygen. Thus, the active material may be structurally stable and may realize excellent high-rate charge and discharge and power characteristics of a rechargeable lithium battery.

In Chemical Formula 1, x (indicating a mole ratio of nickel) may be in a range of about 0.33≦x≦0.80, e.g., about 0.40≦x≦0.80, about 0.50≦x≦0.80, or about 0.60≦x≦0.80. When the nickel has a mole ratio within the range, the positive active material may realize high energy density and high rate capability.

In an implementation, M may be Ti, and w (indicating a mole ratio of Ti) may satisfy the following relation: about 0.005≦w≦0.030, e.g., about 0.005≦w≦0.020 or about 0.010≦w≦0.030. When the titanium is doped or included within the range, high-rate charge and discharge and power characteristics of a rechargeable lithium battery may be improved. For example, the titanium may have a larger ion radius than nickel, cobalt, manganese, or the like. Thus, doping of or including the titanium in an excessive amount may hinder diffusion of lithium ions and may deteriorate high-rate charge and discharge efficiency or high power characteristic of a rechargeable lithium battery. In addition, if an excessive amount of a titanium precursor were used to prepare a positive active material, all the titanium precursor may not be doped, but rather may remain on the surface of an active material. Thus, resistance of the active material may increase and intercalation of lithium may be hindered. Therefore, high-rate charge and discharge efficiency and high power characteristics of a battery may be deteriorated.

In an implementation 1, M may be Zr, and w (representing a mole ratio of Zr) may satisfy the following relation: about 0.001≦w≦0.030, e.g., about 0.001≦w≦0.020, about 0.001≦w≦0.010, or about 0.001≦w≦0.006. When zirconium is doped or included within the range, high-rate charge and discharge and power characteristics of a rechargeable lithium battery may be improved.

The zirconium may also have a large ion radius. Thus, an excessive doping amount of the zirconium may hinder diffusion of lithium ions. In addition, if an excessive amount of a zirconium precursor were to be used to prepare a positive active material, all the zirconium precursor may not be doped, but rather may remain on the surface of an active material. Thus, resistance of the active material may be increased and intercalation of lithium ions may be hindered, resultantly deteriorating high-rate charge and discharge efficiency and high power characteristics of a battery.

The positive active material may have a secondary particle structure including aggregated primary particles. In an implementation, the primary particles may have an average particle diameter of about 0.1 μm to about 1 μm. In addition, the secondary particle may have an average particle diameter of about 3 μm to about 8 μm.

Herein, the average particle diameter is obtained by measuring a specimen using a scanning electron microscope and averaging the measurements.

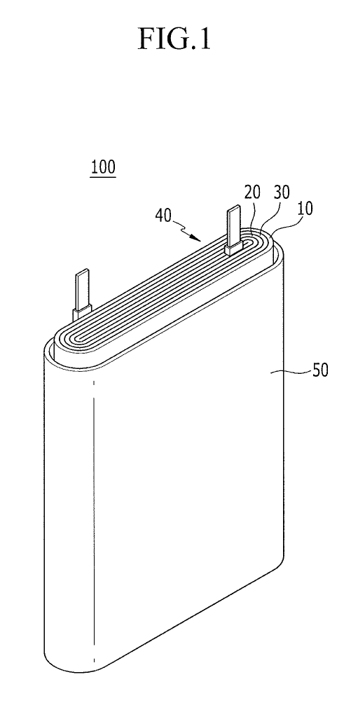

In another embodiment, a rechargeable lithium battery including a positive electrode including the positive active material, a negative electrode, and an electrolyte is provided. Hereinafter, a rechargeable lithium battery including the electrolyte is described referring to FIG. 1.

FIG. 1 illustrates an exploded perspective view of a rechargeable lithium battery according to one embodiment. A prismatic rechargeable lithium battery according to one embodiment is described as an example. However, the embodiments are not limited thereto, an may be applicable to various batteries such as a lithium polymer battery, a cylindrical battery, and the like.

Referring to FIG. 1, the rechargeable lithium battery 100 according to one embodiment may include an electrode assembly 40 manufactured by winding a separator 30 interposed between a positive electrode 10 and a negative electrode 20 and a case 50 housing the electrode assembly 40. An electrolyte (not shown) may be impregnated in the positive electrode 10, the negative electrode 20, and the separator 30.

The positive electrode 10 may include a current collector and a positive active material layer formed on the current collector. The positive active material layer may include a positive active material, a binder, and a conductive material.

The current collector may be, e.g., Al, but is not limited thereto.

The positive active material may be the same as described above and thus, descriptions thereof are not provided.

The binder may help binding properties of the active material particles to each other and to the current collector. Examples of the binder may include polyvinylalcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, epoxy resin, nylon, and the like, but are not limited thereto.

The conductive material may help improve electrical conductivity of an electrode. A suitable electrically conductive material that does not cause a chemical change can be used as a conductive agent. Examples of the conductive material may include natural graphite, artificial graphite, carbon black, acetylene black, ketjen black, a carbon fiber, a metal powder or a metal fiber of copper, nickel, aluminum, silver, and the like, a polyphenylene derivative, and the like.

The negative electrode 20 may include a negative current collector and a negative active material layer formed on the negative current collector.

The negative current collector may include a copper foil. The negative active material layer may include a negative active material and a binder. In an implementation, the negative active material layer may further include a conductive material.

The negative active material may include a material that reversibly intercalates/deintercalates lithium ions, a lithium metal, a lithium metal alloy, a material being capable of doping/dedoping lithium, and/or a transition metal oxide.

The material that reversibly intercalates/deintercalates lithium ions may include carbon materials. The carbon material may be a suitable carbon-based negative active material in a lithium ion secondary battery. Examples of the carbon material may include crystalline carbon, amorphous carbon, and a combination thereof. The crystalline carbon may include non-shaped, or sheet, flake, spherical, or fiber shaped natural graphite or artificial graphite. The amorphous carbon may include a soft carbon, a hard carbon, a mesophase pitch carbonized product, fired coke, or the like.

The lithium metal alloy may include lithium and a metal selected from Na, K, Rb, Cs, Fr, Be, Mg, Ca, Sr, Si, Sb, Pb, In, Zn, Ba, Ra, Ge, Al, and Sn.

The material capable of doping and dedoping lithium may include Si, SiOx (0<x<2), a Si-C composite, a Si-Q alloy (wherein Q is an alkali metal, an alkaline-earth metal, Group 13 to 16 elements, a transition element, a rare earth element, or a combination thereof, and not Si), Sn, SnO₂, a Sn—C composite, a Sn—R alloy (wherein R is an alkali metal, an alkaline-earth metal, Group 13 to 16 elements, a transition element, a rare earth element, or a combination thereof, and is not Sn), or the like. At least one of them may be mixed with SiO₂. In an implementation, the elements Q and R may be selected from, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof.

The transition metal oxide may include vanadium oxide, lithium vanadium oxide, or the like.

The binder may help improve binding properties of the active material particles to each other and to a current collector. Examples of the binder may include polyvinylalcohol, carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, nylon, or the like, but are not limited thereto.

The conductive material may help improve electrical conductivity of the electrode. A suitable electrically conductive material that does not cause a chemical change may be used as the conductive material. Examples of the conductive material may include a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene; or a mixture thereof.

The negative electrode 20 and positive electrode 10 may be manufactured in a method of preparing an active material composition by mixing each active material, a conductive material, and a binder and coating the composition on a current collector.

The electrode manufacturing method may be well known and thus, is not described in detail in the present specification. The solvent may include N-methylpyrrolidone and the like but is not limited thereto.

The electrolyte may include a non-aqueous organic solvent and a lithium salt.

The non-aqueous organic solvent plays a role of transferring ions taking part in the electrochemical reaction of a battery. The non-aqueous organic solvent may include a carbonate-based, ester-based, ether-based, ketone-based, alcohol-based, or aprotic solvent.

The non-aqueous organic solvent according to an embodiment may include ethylene carbonate. The ethylene carbonate may be included in an amount of greater than about 5 volume % to less than about 30 volume %, based on an entire weight of a non-aqueous organic solvent. When the ethylene carbonate is included within the range, deterioration of a battery may be eased. Thus, stability of the battery may be improved. In an implementation, the ethylene carbonate may be included in an amount of about 10 volume % to about 25 volume %.

The non-aqueous organic solvent may further include, e.g., dimethyl carbonate (DMC), diethyl carbonate (DEC), dipropyl carbonate (DPC), methylpropyl carbonate (MPC), ethylpropyl carbonate (EPC), methylethyl carbonate (MEC), propylene carbonate (PC), butylene carbonate (BC), or a combination thereof. The electrolyte including these mixed organic solvents may realize excellent thermal safety and high temperature cycle life characteristic as well as high-capacity of a rechargeable lithium battery.

The ester-based solvent may include, e.g., methyl acetate, ethyl acetate, n-propyl acetate, dimethyl acetate, methyl propionate, ethyl propionate, γ-butyrolactone, decanolide, valerolactone, mevalonolactone, caprolactone, or the like. The ether-based solvent may include, e.g., dibutylether, tetraglyme, diglyme, dimethoxyethane, 2-methyltetrahydrofuran, tetrahydrofuran, or the like. The ketone based solvent may include, e.g., cyclohexanone or the like. The alcohol-based solvent may include, e.g., ethanol, isopropyl alcohol, or the like.

The non-aqueous organic solvent may be used singularly or in a mixture. When the organic solvent is used in a mixture, its mixture ratio can be controlled in accordance with desirable performance of a battery.

The lithium salt may be dissolved in the non-aqueous solvent and may supply lithium ions in a rechargeable lithium battery. For example, the lithium salt may basically operate the rechargeable lithium battery and may help lithium ion transfer between positive and negative electrodes.

The lithium salt may include at least one supporting salt selected from LiPF₆, LiBF₄, LiSbF₆, LiAsF₆, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (wherein, x and y are natural numbers), LiCl, LiI, LiB(C₂O₄)₂ (lithium bis(oxalato)borate, LiBOB), and a combination thereof.

The lithium salt may be used in a concentration of about 0.1 M to about 2.0 M. When the lithium salt is included within the above concentration range, electrolyte performance and lithium ion mobility may be improved due to optimal electrolyte conductivity and viscosity.

The separator 30 may include a suitable material used in a lithium battery as long as it is able to separate the negative electrode 20 from the positive electrode 10 and provides a transporting passage for lithium ions. For example, the separator 30 may be made of a material having a low resistance to ion transportation and an improved impregnation for an electrolyte. In an implementation, the material may be selected from glass fiber, polyester, TEFLON (tetrafluoroethylene), polyethylene, polypropylene, polytetrafluoroethylene (PTFE), or a combination thereof. It may have a form of a non-woven fabric or a woven fabric. For example, a polyolefin-based polymer separator such as polyethylene, polypropylene, or the like may be used for a lithium ion battery. In order to ensure the heat resistance or mechanical strength, a coated separator including a ceramic component or a polymer material may be used. Selectively, it may have a mono-layered or multi-layered structure.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### COMPARATIVE EXAMPLE 1

Preparation of Positive Active Material

Ni(NO₃)₂.6H₂O, Co(NO₃)₂.6H₂O, and Mn(NO₃)₂.4H₂O were put in a reaction co-precipitator in a mole ratio of 6:2:2 and consecutively reacted. A NaOH and NH₄OH solution was sequentially put in the reactor to maintain the solution therein at a pH of 11 to 12. The co-precipitation reaction was performed for 8 hours at a reaction temperature of 50° C. at a solution agitation speed of 500 rpm. Next, a transition-metal hydroxide precursor ((Ni_{0.6}Co_{0.2}Mn_{0.2})OH₂) produced from the reaction was washed several times with water and dried at 120° C. in an oven. The dried transition-metal hydroxide precursor was mixed with lithium carbonate (Li₂CO₃) to have a Li/Me (Me: transition metal) mole ratio of 1.03. The mixture was fired at 800° C. for 10 hours, preparing a positive active material represented by Chemical Formula LiNi_{0.6}Co_{0.2}Mn_{0.2}O₂.

Manufacture of Rechargeable Lithium Battery Cell

The positive active material, Denka Black, and a polyvinylidenefluoride polymer binder were mixed in a weight ratio of 86.8:8.7:4.5 in an N-methylpyrrolidone solvent to prepare uniform slurry. The slurry was coated on a positive aluminum current collector and then, dried and compressed.

Then, the positive electrode was used with a carbon-based negative electrode using graphite and an electrolyte (prepared by mixing ethylene carbonate (EC), ethylmethylcarbonate (EMC), and dimethylcarbonate (DMC) in a volume ratio of 2:4:4 and dissolving 1.5M LiPF₆ in the mixed solvent), fabricating a rechargeable lithium battery cell.

### COMPARATIVE EXAMPLE 2

A positive active material and a rechargeable lithium battery cell were fabricated according to the same method as Comparative Example 1 except for further adding 0.789 g of MgO to prepare a transition metal hydroxide precursor. The positive active material prepared according to Comparative Example 2 was LiNi_{0.6}Co_{0.2}Mn_{0.17}Mg_{0.03}O₂.

### COMPARATIVE EXAMPLE 3

A positive active material and a rechargeable lithium battery cell were fabricated according to the same method as Comparative Example, 1 except for further adding TiO₂ to prepare a transition elements hydroxide precursor, so that a positive active material included titanium in an amount of 0.07 mol %. The positive active material according to Comparative Example 3 was LiNi_{0.6}Co_{0.2}Mn_{0.17}Ti_{0.07}O₂.

### EXAMPLE 1

A positive active material and a rechargeable lithium battery cell were fabricated according to the same method as Comparative Example 1 except for further using 1.027 g of TiO₂ to prepare a transition metal hydroxide precursor. The positive active material prepared in Example 1 was LiNi_{0.6}Co_{0.2}Mn_{0.18}Ti_{0.02}O₂. The positive active material had a structure of a secondary particle including aggregated primary particles, and the secondary particle had an average particle diameter of about 6.5 μm.

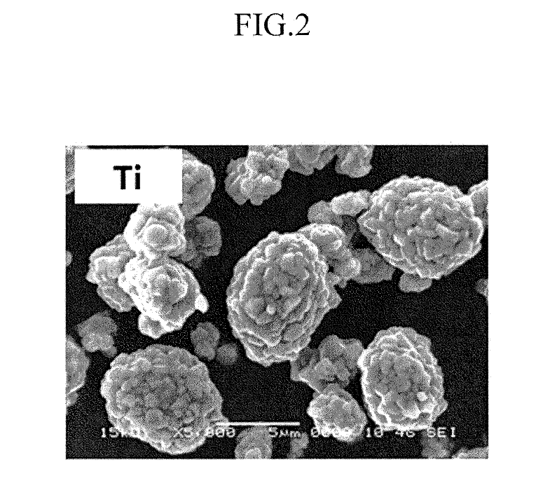

FIG. 2 illustrates a scanning electron microscope (SEM) image showing the positive active material according to Example 1.

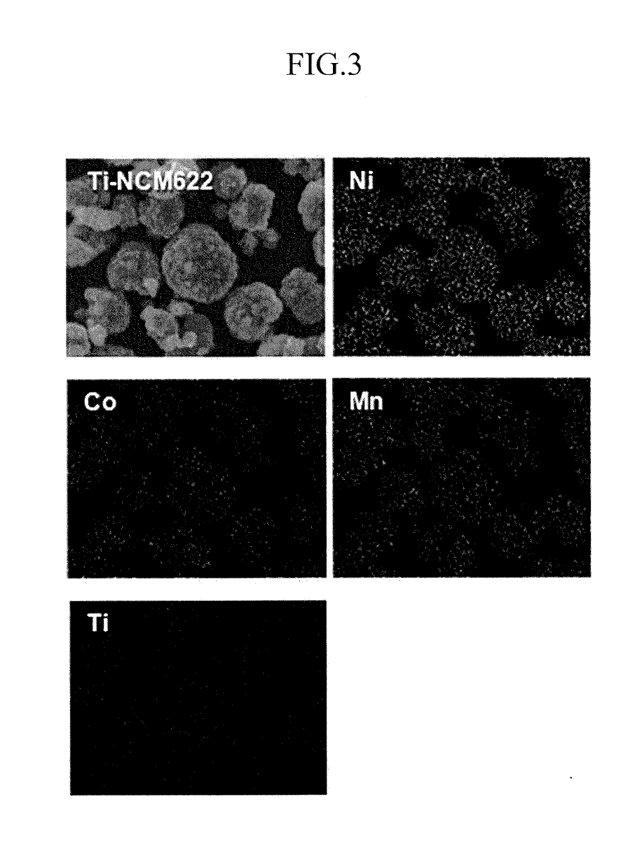

FIG. 3 illustrates an energy-dispersive X-ray spectroscopy (EDX) image showing the positive active material according to Example 1.

Referring to FIG. 3, it may be seen that a titanium element was uniformly distributed in the positive active material.

### EXAMPLE 2

A positive active material and a rechargeable lithium battery cell were fabricated according to the same method as Comparative Example 1 except for further using 0.577 g of ZrO₂ to prepare a transition metal hydroxide precursor. The positive active material according to Example 2 was LiNi_{0.6}Co_{0.2}Mn_{0.194}Zr_{0.006}O₂. The positive active material had a structure of a secondary particle including aggregated primary particles, and the secondary particle had an average particle diameter of about 6.5 μm.

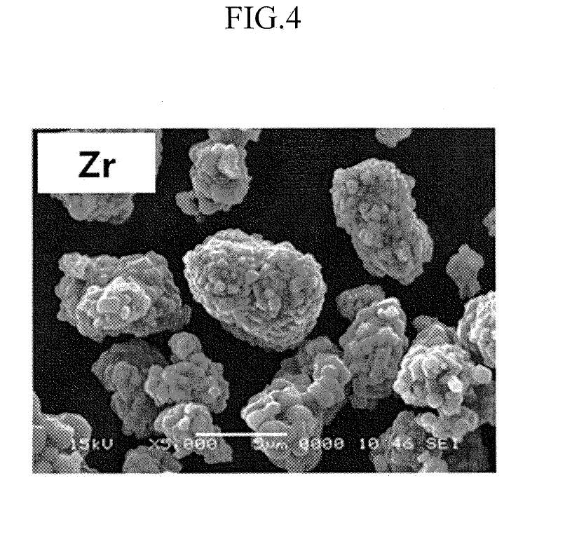

FIG. 4 illustrates a scanning electron microscope image showing the positive active material according to Example 2.

### EVALUATION EXAMPLE 1

### High Rate Discharge Characteristic

The rechargeable lithium battery cells according to Examples 1 and 2 and Comparative Examples 1 to 3 were measured regarding discharge capacity according to C-rate. The discharge capacity was measured by consecutively increasing a current from 1 C to 35 C during the charge and discharge and then, giving a pause for 30 minutes after the charge and discharge at each C rate.

As for capacity retention at 35 C, the rechargeable lithium battery cell according to Comparative Example 1 had 55%, the rechargeable lithium battery cell according to Comparative Example 2 had 44%, the rechargeable lithium battery cell according to Example 1 had 61%, and the rechargeable lithium battery cell according to Example 2 had 75%. Thus, it may be seen that the rechargeable lithium battery cells according to Examples 1 and 2 had higher capacity retention than those of the rechargeable lithium battery cells according to Comparative Examples 1 to 3.

For example, the rechargeable lithium battery cell including the amount of titanium according to Comparative Example 3 exhibited as insufficient a capacity retention as that of the rechargeable lithium battery cell according to Comparative Example 1. However, the rechargeable lithium battery cell including the amount of titanium according to Example 1 exhibited remarkably excellent capacity retention, compared with that of the rechargeable lithium battery cell according to Comparative Example 3.

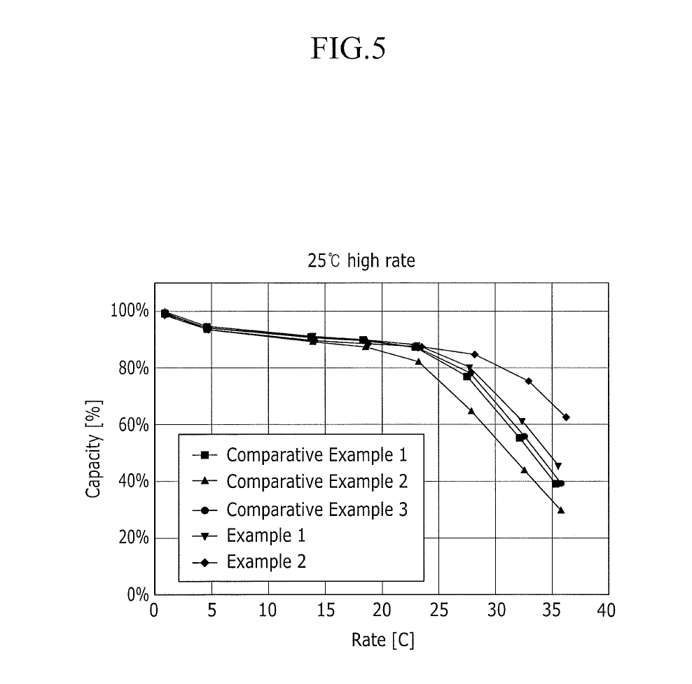

Referring to FIG. 5, the rechargeable lithium battery cells according to Examples 1 and 2 exhibited remarkably excellent discharge retention at a high rate of greater than or equal to 25 C, compared with the rechargeable lithium battery cells according to Comparative Examples 1 to 3.

### EVALUATION EXAMPLE 2

### Output Characteristic

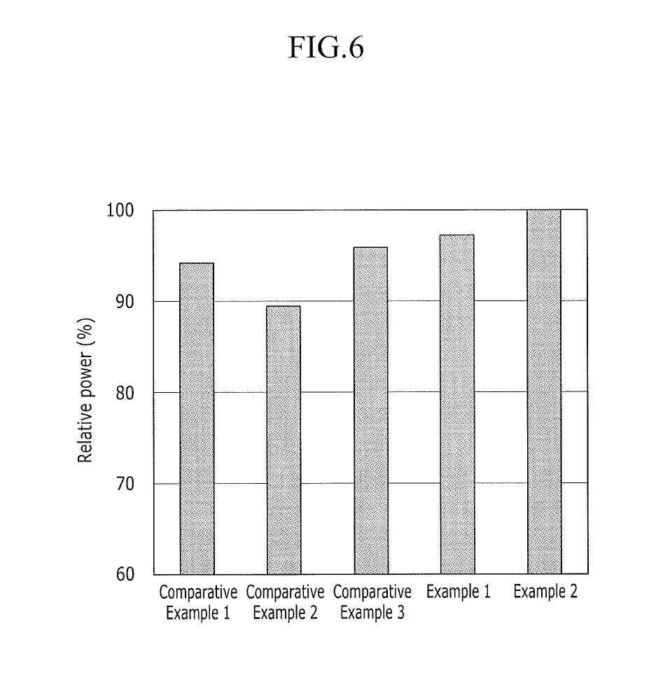

The rechargeable lithium battery cells were measured regarding output characteristic by using a voltage obtained when a current corresponding to an SOC of 50% was applied thereto for 10 seconds. The results are provided in FIG. 6. Referring to FIG. 6, the rechargeable lithium battery cell according to Comparative Example 1 had a power of 94%, the rechargeable lithium battery cell of Comparative Example 2 had a power of 90%, and the rechargeable lithium battery cell of Example 1 had a power of 97%, when the rechargeable lithium battery cell according to Example 2 had an output of 100%. Accordingly, the rechargeable lithium battery cells according to Examples 1 and 2 exhibited improved power characteristic compared with the rechargeable lithium battery cells according to Comparative Examples 1 to 3.

By way of summation and review, rechargeable lithium batteries may be used by injecting an electrolyte into or around an electrode assembly including a positive electrode (including a positive active material that can intercalate and deintercalate lithium) and a negative electrode (including a negative active material that can intercalate and deintercalate lithium). The positive active material may include, e.g., LiCoO₂, but such a material may have a capacity limit and there may be safety concerns. Accordingly, an alternative material may be used.

For example, LiCoO₂ may have stable electrochemical characteristics, LiNiO₂ may have a high-capacity, and LiMnO₂ may exhibit excellent thermal stability and a low cost. Thus, three component-based lithium metal composite oxides of cobalt-nickel-manganese, which combine these three advantages, may be used. However, while the three component-based lithium metal composite oxides may have high-capacity, stability cycle-life and output characteristics may be insufficient.

The embodiments provide a positive active material for a rechargeable lithium battery having high cycle-life characteristics and power characteristics at high rates.

The positive active material for a rechargeable lithium battery according to an embodiment may have high-capacity and excellent cycle-life characteristics and power characteristics at high rates.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A positive active material for a rechargeable lithium battery, the positive active material comprising a compound represented by the following Chemical Formula 1:
LiₐNiₓCo_{y}Mn_{z}M_{w}O₂ [Chemical Formula 1]
wherein, in Chemical Formula 1, M is Ti, or Zr, and ab, x, y, z, and w satisfy the following relations: 0.90≦a≦1.11, 0.33≦x≦0.80, 0.10≦y≦0.33, 0.009≦z≦0.33, 0≦w≦0.03, and x+y+z+w=1.

2. The positive active material for a rechargeable lithium battery as claimed in claim 1, wherein in Chemical Formula 1, M is Ti, and 0.005≦w≦0.030.

3. The positive active material for a rechargeable lithium battery as claimed in claim 1, wherein in Chemical Formula 1, M is Ti, and 0.005≦w≦0.020.

4. The positive active material for a rechargeable lithium battery as claimed in claim 1, wherein in Chemical Formula 1, M is Zr, and 0.001≦w≦0.030.

5. The positive active material for a rechargeable lithium battery as claimed in claim 1, wherein in Chemical Formula 1, M is Zr, and 0.001≦w≦0.020.

6. The positive active material for a rechargeable lithium battery as claimed in claim 1, wherein:
the positive active material has a structure of a secondary particle including aggregated primary particles, and
an average particle diameter of the primary particle is about 0.1 μm to about 1 μm.

7. The positive active material for a rechargeable lithium battery as claimed in claim 6, wherein an average particle diameter of the secondary particle is about 3 μm to about 8 μm.

8. The positive active material for a rechargeable lithium battery as claimed in claim 1, wherein, in Chemical Formula 1, 0.001≦w≦0.006.

9. A rechargeable lithium battery, comprising
a positive electrode, the positive electrode including the positive active material as claimed in claim 1;
a negative electrode; and
an electrolyte.
